(19) United States
(12) Patent Application Publication
(10) Pub. No.: US 2024/0124190 A1
(43) Pub. Date: Apr. 18, 2024

(54) CONTAINER

(71) Applicant: LOADHOG LIMITED, Sheffield, South Yorkshire (GB)

(72) Inventors: Martin Baker, Sheffield, South Yorkshire (GB); Allan McCabe, Sheffield, South Yorkshire (GB)

(21) Appl. No.: 18/278,274

(22) PCT Filed: Mar. 11, 2022
(86) PCT No.: PCT/IB2022/052205

§ 371 Date: Aug. 22, 2023

(30) Foreign Application Priority Data
Mar. 18, 2021 (GB) 2103760.1
May 13, 2021 (GB) 2106797.0
Sep. 6, 2021 (GB) 2112645.3
Mar. 3, 2022 (GB) 2202961.5

(51) Int. Cl. B65D 21/02; B65D 21/06; B65D 43/06

(52) U.S. Cl. CPC B65D 21/0212; B65D 21/064; B65D 21/066; B65D 43/06

(57) ABSTRACT

A container (10) comprising a wall arrangement (12) defining a load receiving space (16), and a support member (14) attached on the wall arrangement (12), the support member (14) being movable between a support position and a non-support position, wherein, in the support position, the support member (14) extends at least partially across the load receiving space (16), the support member having a planar portion (30) to support a further container (10) in a stacked condition on the container (10).

This invention relates to containers. This invention also relates to container arrangements comprising containers and lids.

It is often necessary to stack full containers on one another, for example, to store or transport the goods held therein. The stacking can be effected either by providing first formations at the upper edge region of the walls of a first container which cooperate with second formations at the base of a second container stacked on the first container. In one example of such containers, the first formations are in the form of bale arms.

According to one aspect of this invention, there is provided a container comprising a wall arrangement defining a load receiving space, and a support member attached on the wall arrangement, the support member being movable between a support position and a non-support position, wherein, in the support position, the support member extends at least partially across the load receiving space, the support member having a planar portion to support a further container in a stacked condition on the first mentioned container.

The wall arrangement may comprise a plurality of walls. The support member may be attached on one of the walls.

The container may comprise two of the aforesaid support members. The support members may be arranged opposite each other.

The wall arrangement may comprise four walls. The planar portion may be substantially planar.

The wall arrangement may comprise two opposite first walls and two opposite second walls. The support members may be arranged on opposite first walls.

Each of the opposite first walls may have an upper edge region. The support members may be pivotally attached to the upper edge regions of the opposite first walls.

Each support member may be pivotally attached to the respective first wall by a hinge and a hinge member. The hinge may be provided on the first wall. The hinge member may extend from the planar portion. The hinge may define a channel.

The hinge member may be received in the channel. The receipt of the hinge member in the channel may allow the support member to pivot between the support and non-support positions.

The container may have a first dimension extending across the top of the load receiving space between the first walls. The container may have a second dimension extending across the top of the load receiving space between the second walls.

Each planar portion may have a width extending between the first walls. The width of each planar portion may be such that, in the support position, both support members extend across an aggregate of 20% to 25% of the first dimension of the container.

In the non-support position, the, or each, support member may be arranged substantially parallel to the wall to which the support member is attached.

The, or each, support member may be pivotally attached to the wall arrangement. The pivotal attachment may be at an upper edge region of the wall arrangement.

In the support position, the, or each, support member may extend transverse relative to the wall arrangement. In the non-support position, the, or each, support member may extend upwardly relative to the wall arrangement.

In the non-support position, the, or each, support member may project above the wall arrangement.

The second walls may have receiving formations for receiving the support members in the support position. Each receiving formation may comprise an indentation defined by the second wall. Each indentation may be an inwardly facing indentation.

Each receiving formation may include a ledge on which the support member is seated in the support position. Each indentation may be defined in the upper edge region of the second wall adjacent the first walls.

The, or each, support member may have a locating formation on the planar portion. The locating formation may cooperate with a corresponding formation on the further container or on a lid to locate the further container, or the lid, on the support member.

The corresponding formation on the further container may be the base of the container. Said corresponding formation may be the perimeter of the base of the container.

A container arrangement may comprise the container and a lid. The upper edge region of the wall arrangement of the container may include pivot formations to provide a pivotal mounting for the lid.

The pivot formations may be provided on the opposite second walls of the wall arrangement. Thus, in the embodiment described herein, the pivot formations allow the lid to pivot between open and closed positions about either of said opposite second walls.

Each of the opposite second walls may have an upper edge region. The pivot formations may be provided at the upper edge regions of the opposite second walls.

Each pivot formation may comprise a recess defined in an upper edge region of one of the second walls. Each pivot formation may further include a pair of upstanding members extending across the recess.

Each recess may have a lower end. The upstanding members may extend upwardly from the lower end.

The lid may include cooperating formations for cooperating with the upstanding members. The cooperating formations may cooperate with the upstanding members to allow the lid to pivot about said upstanding members between the open and closed positions.

The lid may have a main part that extends across the load receiving space when the lid is in the closed position. Each cooperating formation may extend downwardly from the main portion.

When the lid is disposed in the closed position, each cooperating formation may cooperate with respective pivot formations.

Each cooperating formation may comprise a pivot member. Each pivot member may be received between the upstanding members. Each pivot member may comprise a pivot pin.

The lid may have opposite rim regions. At least one of the cooperating formations may be provided on each of said opposite rim regions.

The lid may be movable from the closed position to a first open position, in which the lid is pivoted about the pivot formation on one of said opposite upper edge regions.

The lid may be movable from the closed position to a second open position, in which the lid is pivoted about the pivot formation on the other of said opposite upper edge regions.

The wall arrangement may comprise two of the pivot formations in each of the opposite second walls. The lid may comprise two of the cooperating formations on each of said opposite rim regions.

Alternatively, the, or each, pivot formation may include a lug member. The, or each, lug member may be provided within the recess.

The, or each, lug member extend upwardly from the lower end of the recess. The, or each, pivot formation may include an occlusion region extending across the recess. The second wall may provide the occlusion region. The, or each, occlusion region may be a region of the second wall.

The lug member and the occlusion region may define therebetween a receiving formation in which a respective one of the cooperating formations may be received.

The, or each, receiving formation may have an upper opening. The upper opening may face externally of the container.

The receiving formation may define two opposite side openings. A pair of gripping formations may be provided on the, or each, occlusion region. Each gripping formation may be provided adjacent a respective side opening. Each gripping formation may extend downwardly along the occlusion region.

The, or each, cooperating formation may comprise a resiliently deformable securing member. Each cooperating formation may comprise a pair of the resiliently deformable securing members.

Each resiliently deformable securing member may extend downwardly from each of the opposite rim regions of the lid. Each securing member may comprise an inwardly projecting securing portion and a resilient connecting portion.

Each connecting portion may connect the respective securing portion to the main part of the lid.

The, or each, cooperating formation may comprise a pair of securing members. The securing portions of each pair of securing members may project towards each other.

The securing portions may be received by the respective receiving formations to mount the lid on the container.

The side openings of the, or each, receiving formation may receive the securing members therethrough. When so received, the securing members may be gripped between the lug member and the gripping formations.

Thus, the, or each, cooperating formation is secured to the, or the respective, receiving formation by the securing members being received through the side openings defined by the receiving formation.

The lid may be moveable to an open position by releasing the, or each, securing member from the pivot formations along one of the second walls. The, or each, securing member may be released by deforming the securing members away from each other out of the respective receiving formation.

The lid may be pivoted about the, or each, pivot formation on the second wall to the open position.

The, or each, securing portion may be released from the, or the respective, pivot formations through the open face. The, or each, securing portion may snap out of the, or the respective, pivot formation through the open face.

At least one embodiment of the invention will now be described by way of example only, with reference to the accompanying drawings, in which:

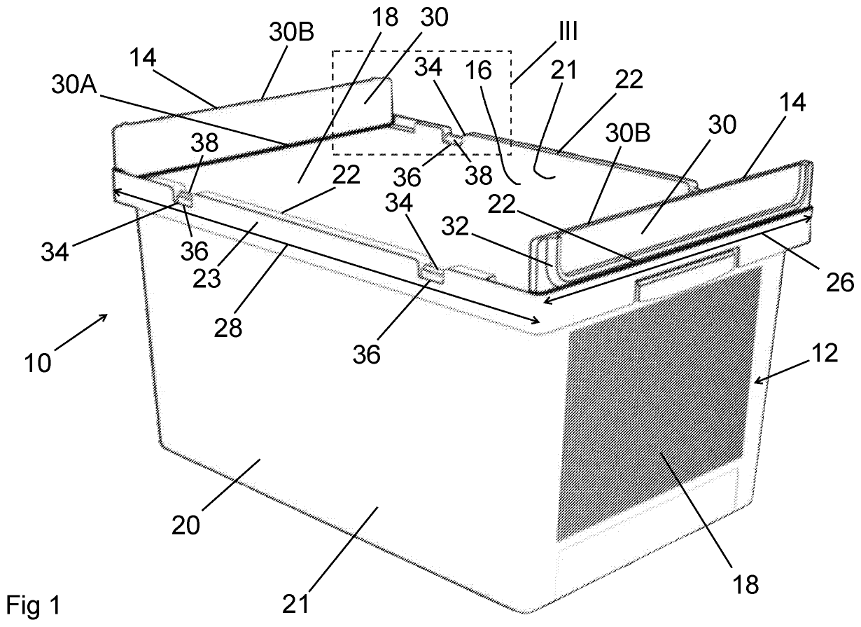

FIG. 1 is a perspective view of a container, showing support members in a non-support position;

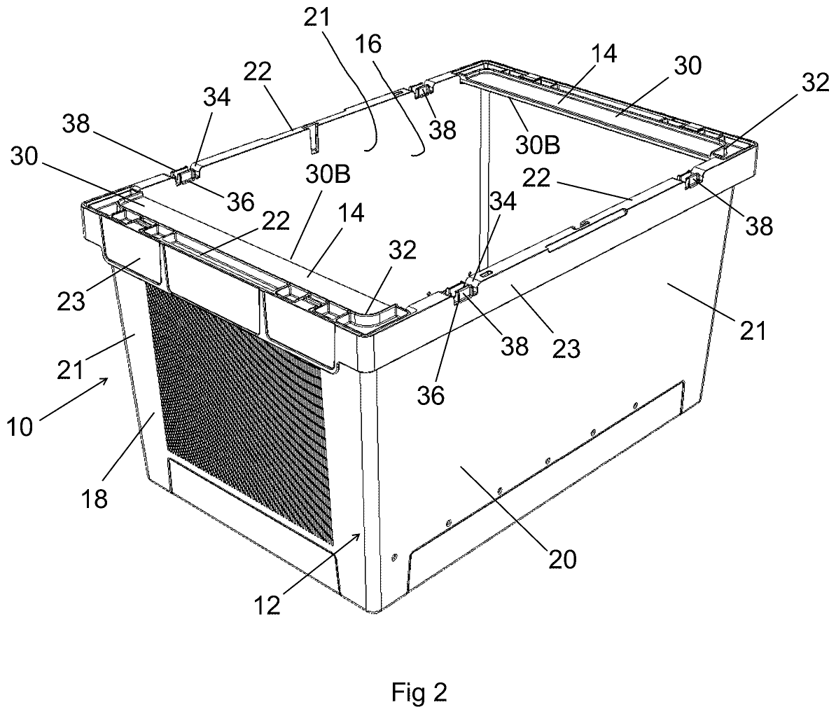

FIG. 2 is a perspective view of the container, in which support members are shown in a support position;

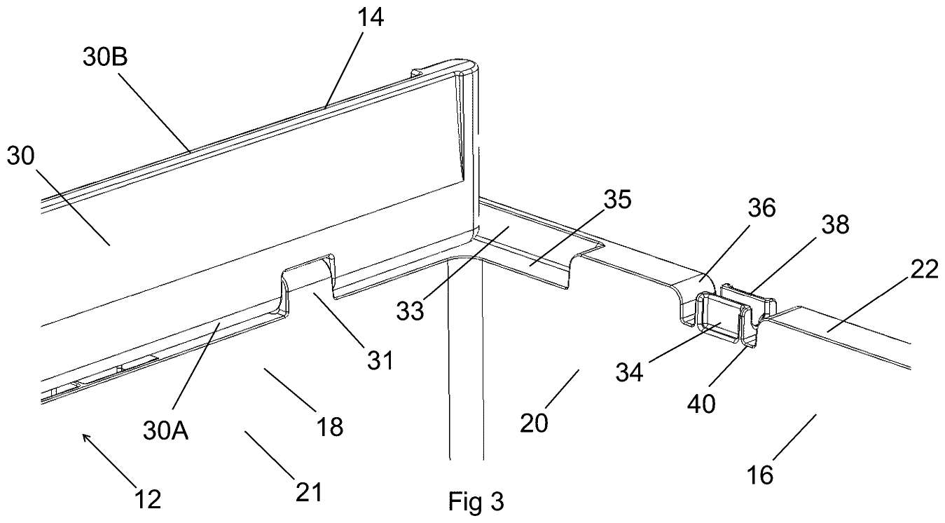

FIG. 3 is a close up view of the region marked III in FIG. 2;

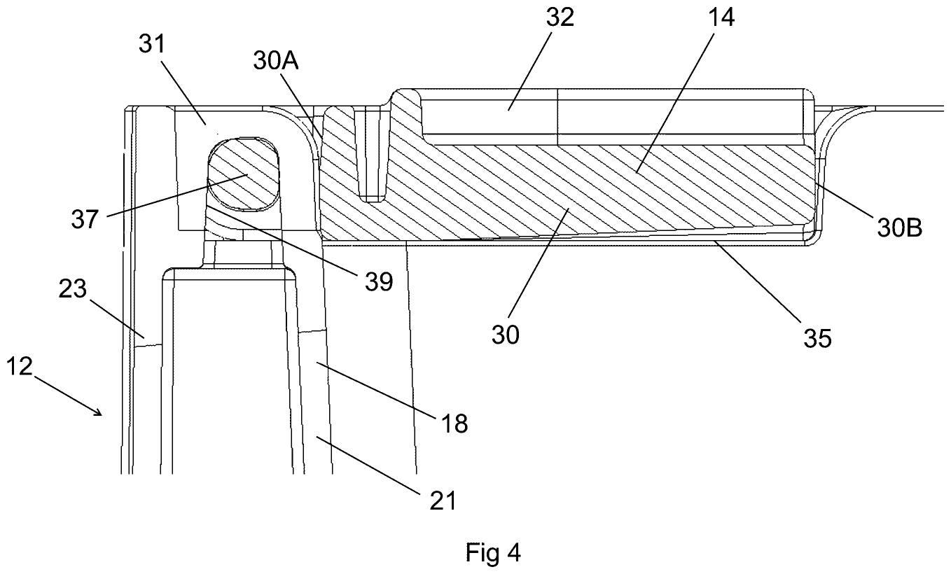

FIG. 4 is a sectional view through one of the support members, showing the attachment of the support member to a wall of the container;

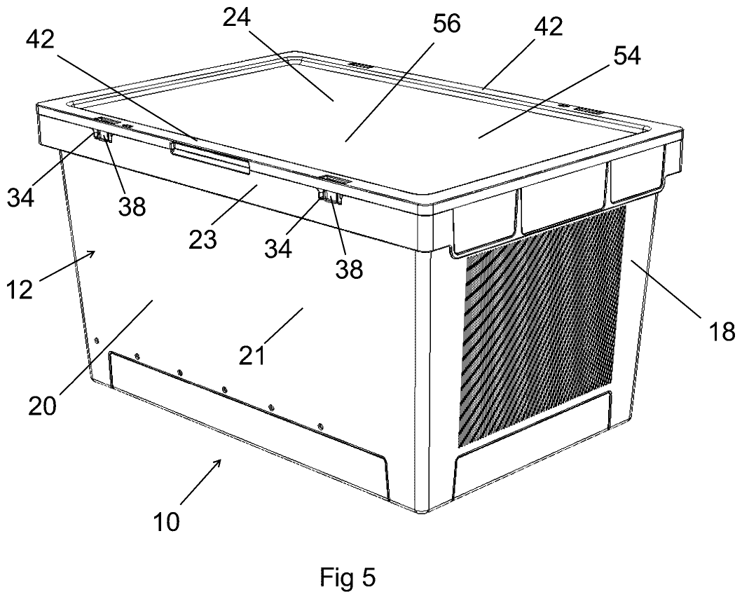

FIG. 5 shows the container with a lid in a closed position;

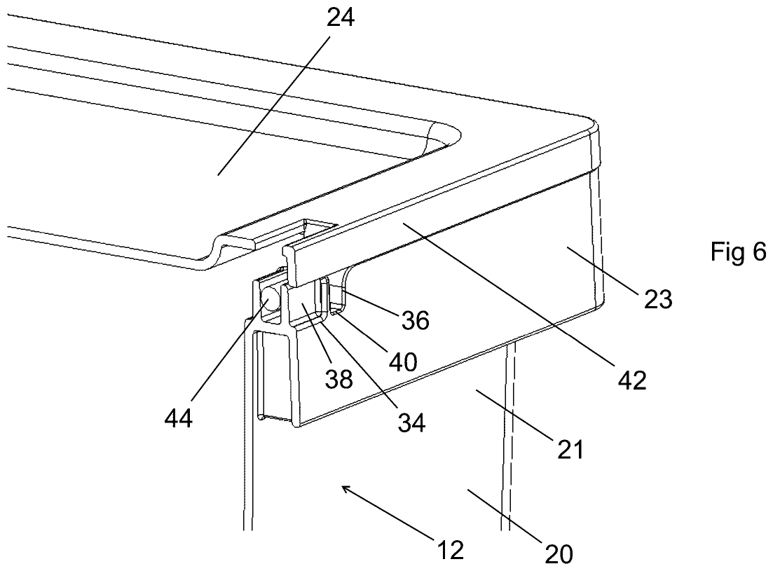

FIG. 6 is a close up sectional view of a region of the container showing the attachment of the lid to a pivot formation;

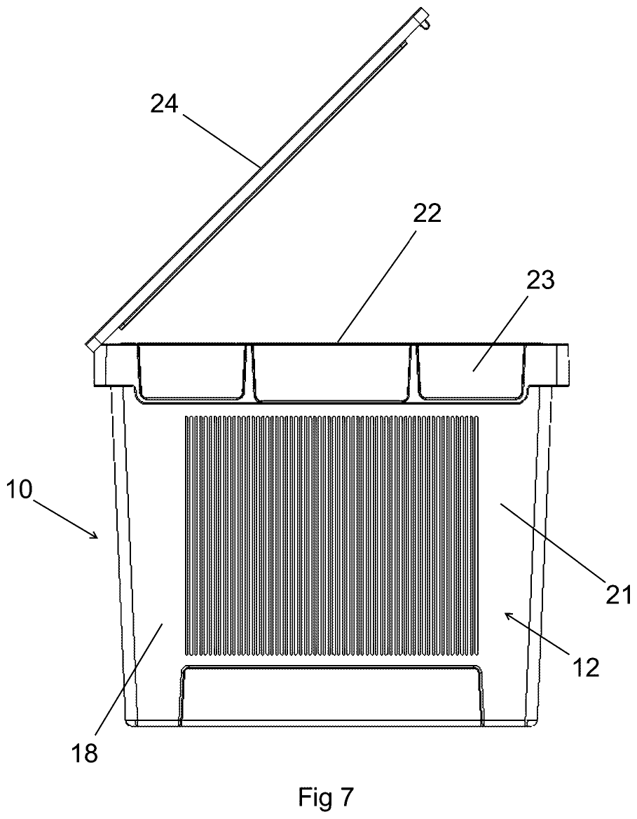

FIG. 7 is an end view of the container with the lid in a first open position;

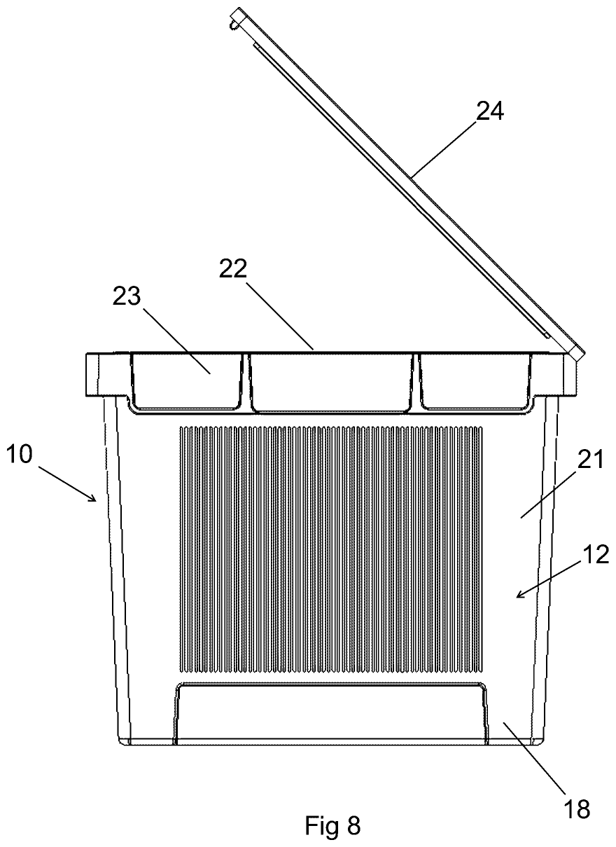

FIG. 8 is a view of the same end of the container as shown in FIG. 4, in which the lid is shown in a second open position;

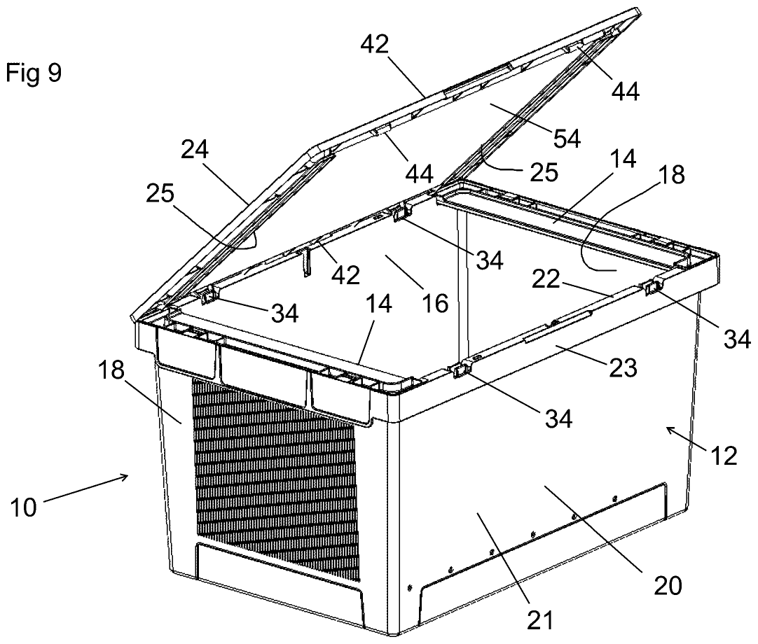

FIG. 9 is a perspective view of the container, showing the lid in the first open position;

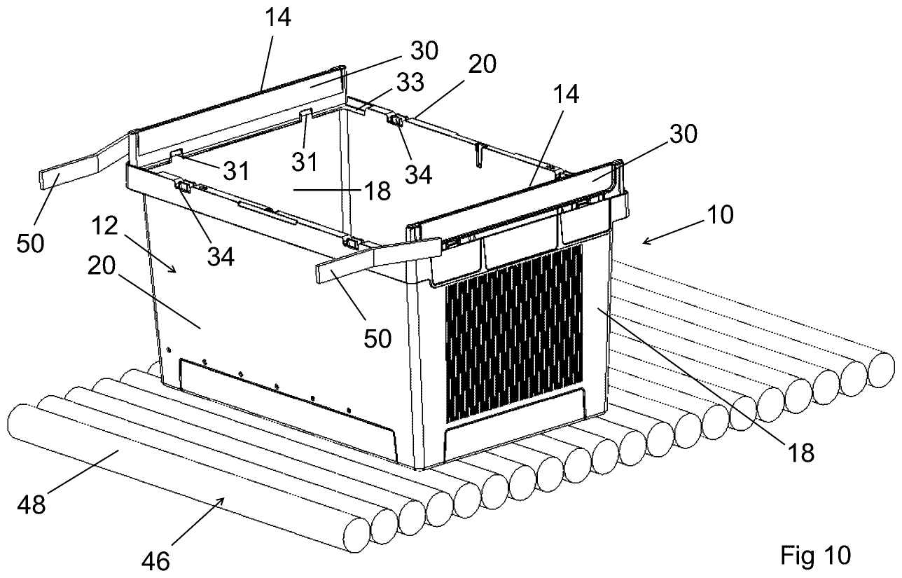

FIG. 10 shows the container on a conveying apparatus;

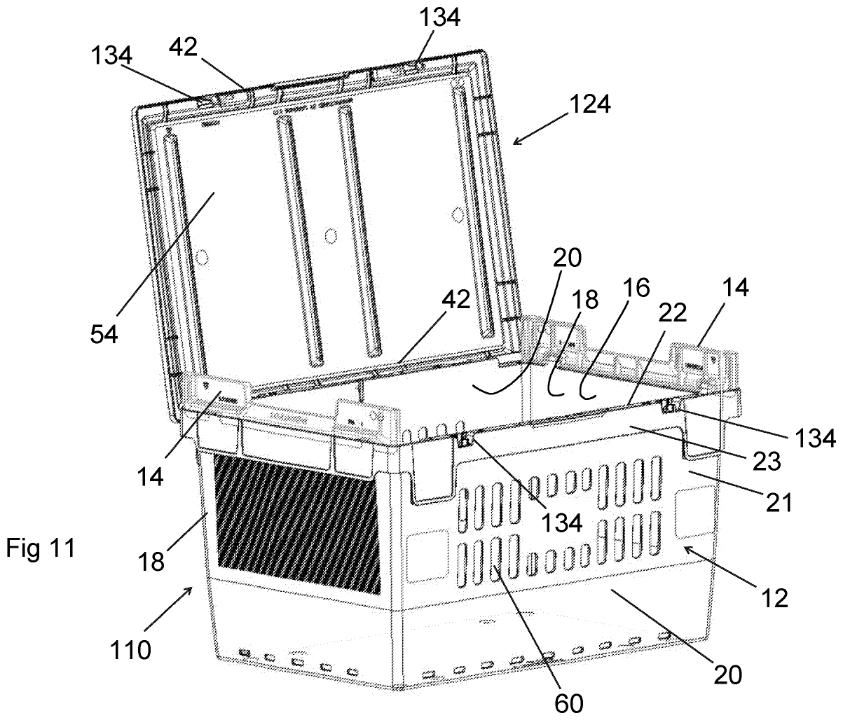

FIG. 11 is a perspective view from the front of a further container with a further lid in an open position;

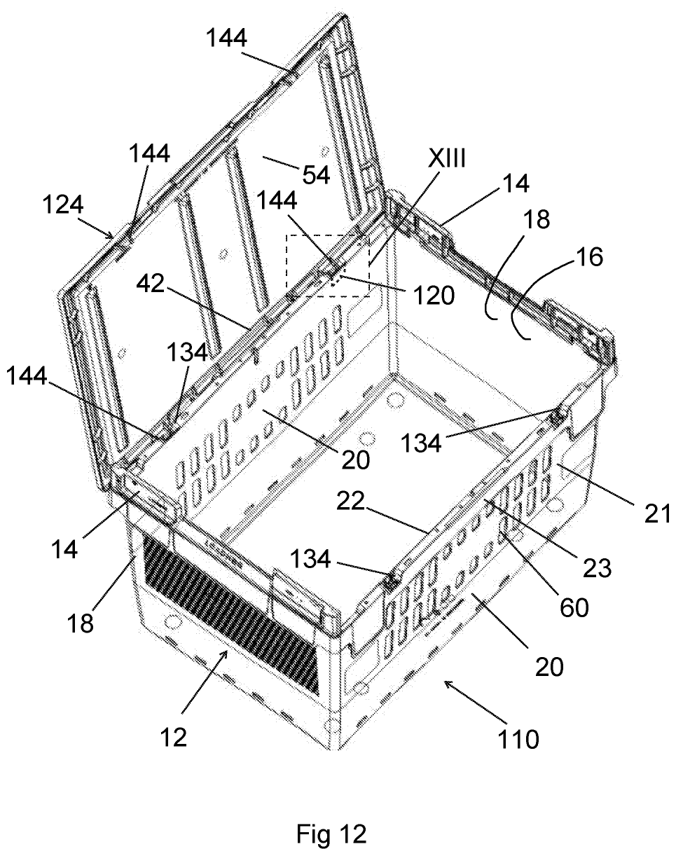

FIG. 12 is a perspective view from above of the further container shown in FIG. 11;

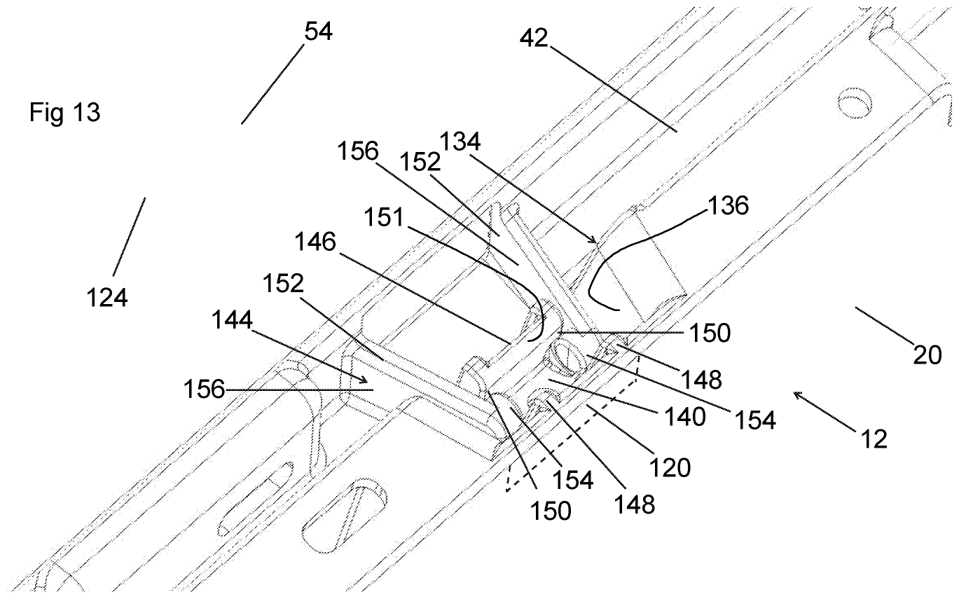

FIG. 13 is a close up view of the region marked XIII in FIG. 12, in which the lid is in an open position;

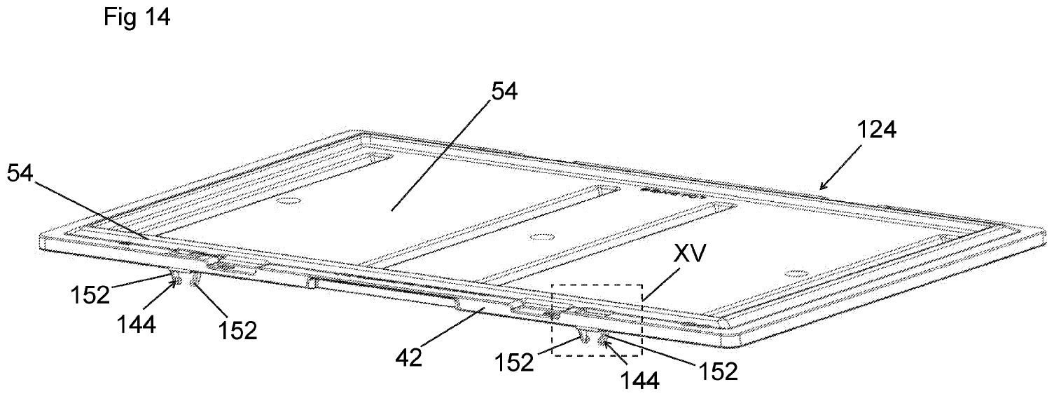

FIG. 14 is a perspective view of the further lid;

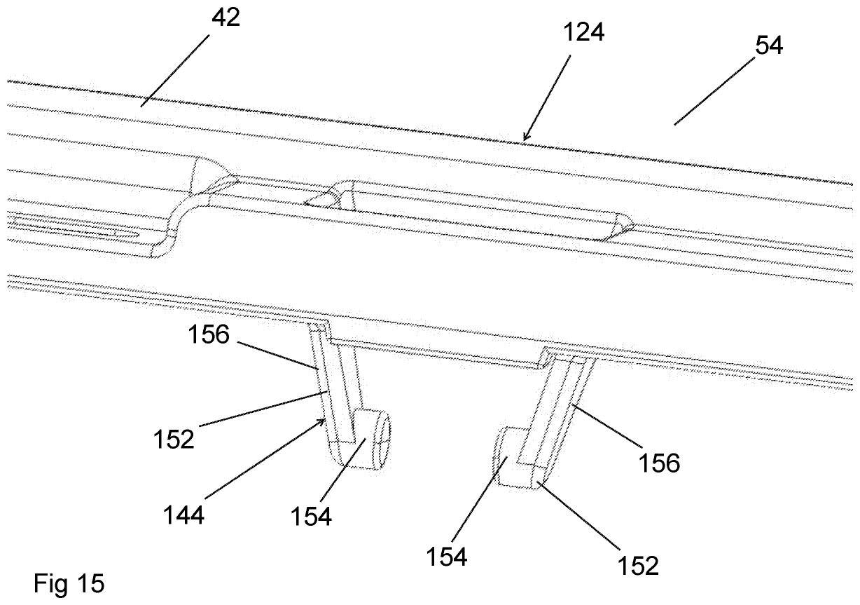

FIG. 15 is a close up view of the region marked XV in FIG. 14;

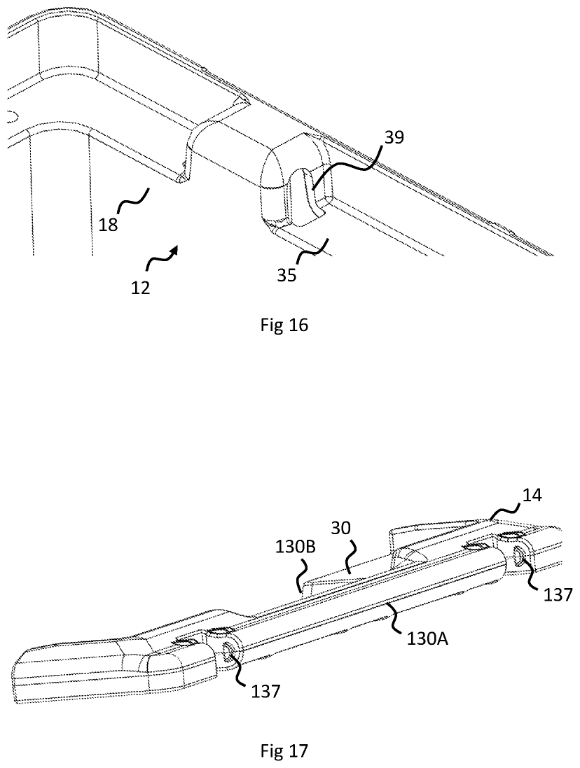

FIG. 16 is a perspective view of a hinge channel of a further container;

FIG. 17 is a perspective view of a further support member with modified hinge members;

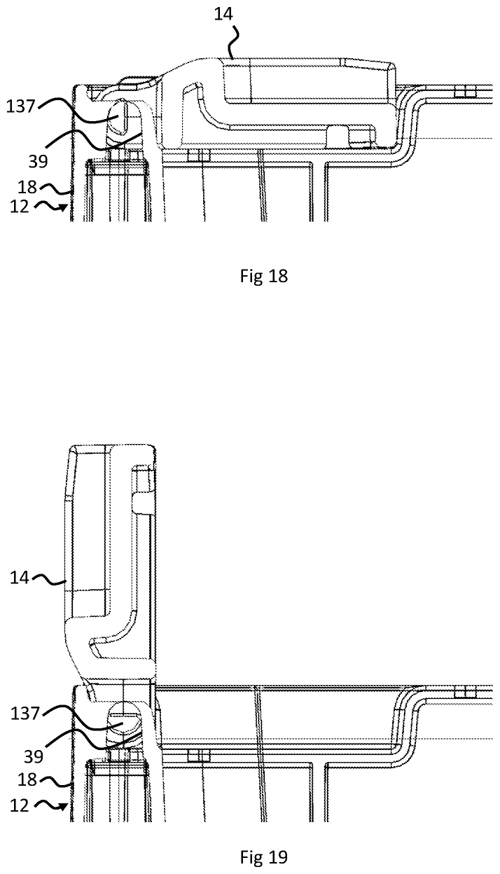

FIG. 18 is a side cross-section view of the support member, with the modified hinge members, in a support position; and

FIG. 19 is a side cross-section view of the support member, with the modified hinge members, in a non-support position.

The drawings show a container 10 comprising a wall arrangement 12 and two support members 14, each support member 14 being in the form of a flap. The support members 14 are pivotally attached opposite each other to the wall arrangement 12.

The wall arrangement 12 defines a load receiving space 16. The support members 14 are provided to support a further container 10 on the container 10 over the load receiving space 16, in a stacked condition of the containers 10.

The wall arrangement 12 comprises two opposite first walls 18 and two opposite second walls 20. Each of the first and second walls 18, 20 has a main portion 21, an upper edge region 22, and a downwardly extending outer portion 23 extending across an upper region of the main portion 21.

The support members 14 are pivotally attached to the first walls 18 at the upper edge regions 22 thereof.

An optional lid 24 may be provided for the container 10. The lid 24 is arrangeable on the wall arrangement 12, as shown in FIG. 5. When used, the lid 24 provides a degree of security, and protection from contamination, for the contents of the container 10.

The container 10 has a first dimension 26 extending across the load receiving space 16 between the upper edge regions 22 of the first walls 18. The container 10 also has a second dimension 28 extending across the load receiving space 16 between the upper edge regions 22 of the second walls 20.

Each support member 14 is pivotally movable between a support position shown in FIG. 2 and a non-support position shown in FIG. 1. In the support position, the support member 14 extends partially across the load receiving space 16, transverse to the wall arrangement 12.

Each support member 14 comprises a planar portion 30 and a locating formation 32 on the planar portion 30.

When the support members 14 are in their support positions, the locating formation 32 is co-operable with the base of the further container 10 stacked on the container 10, or with a corresponding formation 25 on the lid 24, to locate the further container 10 or the lid 24 on the support member 14.

The lid 24 is supported mainly by the first and second walls 18, 20. The support members 14 provide some additional support for the lid 24. The further container 10 is supported by the support members 14.

The locating formation 32 is in the form of an elongate C shaped raised member on the planar portion 30. The locating formation 32 is configured to engage around the base of the further container 10.

Referring to FIG. 3, each of the second walls 20 defines inwardly facing indentations 33, which provide ledges 35. The indentations 35 are defined in the upper edge regions 22 adjacent each of the first walls 18. The support members 14 are seated on the ledges 35 when the support members 14 are in their support positions.

The planar portion 30 of each support member 14 has two opposite long edges 30A, 30B (see FIG. 2). The long edge 30A is attached to one of the first walls 18 at hinges 31. The other long edge 30B is a free edge.

Each planar portion 30 has a width extending between the long edges 30A, 30B. The width of each planar portion 30 is such that, in the support position, both support members 14 extend across an aggregate of 20% to 25% of the first dimension 26 of the container 10.

The attachment of one of the support members 14 to one of the hinges 31 is shown in more detail in FIGS. 3 and 4. The support member 14 has two hinge members 37 (only one of which is shown in FIG. 4) extending from the planar portion 30.

Each of the hinge members 37 is received in a channel 39 defined by the respective hinge 31, thereby allowing the support member 14 to pivot between the support and non-support positions.

In the non-support position, the support members 14 extend upwardly to project from the wall arrangement 12, and each support member 14 is arranged substantially parallel to the first wall 18 on which the support member 14 is attached.

The upper edge region 22 of each of the opposite second walls 20 includes two pivot formations 34 to provide a pivotal mounting for the lid 24. The lid 24 can be pivoted about the pivot formations 34 of either upper edge region 22, as shown in FIGS. 7 and 8.

Pivoting of the lid 24 about one of the upper edge regions 22 allows access to the contents of the container 10 from either side of the container 10. This avoids the need to turn the container round to access its contents, and is advantageous if the articles stored in the container 10 are heavy.

Each pivot formation 34 comprises a recess 36 defined in the upper edge region 22 of the second wall 20. Each pivot formation 34 further includes a pair of parallel upstanding members 38 extending across the recess 36.

Each recess 36 has a lower end 40. The upstanding members 38 extend upwardly from the lower end 40.

Referring to FIGS. 5 and 6, the lid 24 has opposite rim regions 42, and includes two downwardly extending cooperating formations 44 on each of its opposite rim regions 42. Each cooperating formation 44 is in the form of a pivot member.

The cooperating formations 44 are received between the upstanding members 38, thereby allowing the lid 24 to pivot about upstanding members 38 between open and closed positions.

The lid 24 has a main part 54 that extends across the load receiving space 16 when the lid 24 is in the closed position (see FIG. 3).

The lid 24 is pivotally movable from the closed position to a first open position shown in FIGS. 4 and 6, in which the lid 24 is shown pivoted about the pivot formation 34 on one of said opposite upper edge regions 22.

The lid 24 is pivotally movable from the closed position to a second open position shown in FIG. 5, in which the lid 24 is shown pivoted about the pivot formation 34 on the other of said opposite upper edge regions 22.

In use, the support members 14 are moved to their support position, as shown in FIG. 2. A load, which may comprise a plurality of articles, is then disposed in the load receiving space 16.

The container 10 can then be arranged on a suitable conveying apparatus 46 shown in FIG. 10. The conveying apparatus 46 comprises a conveyor 48 and urging members 50 to urge the support members 14 from the support position shown in FIGS. 2 and 8, to the non-support position shown in FIG. 1.

The urging members 50 are in the form of arms. The urging members 50 are positioned by an appropriate part of the apparatus 46 (not shown for reasons of clarity).

Thus, a user can fill a plurality of the containers 10 with articles, and dispose each filled container 10 one at a time onto the conveyor 48 of the conveying apparatus 46.

The conveyor 48 conveys the containers 10 to a further location, for example a location at which the containers 10 can be stored or despatched. While being conveyed, the support members 14 are moved into contact with the urging members 50, which urge the support members 14 to their no-support positions.

When the containers 10 reach the further location, another user can remove them from the conveyor 48, and stack them upon one another for storage or to await despatch.

When so stacked, the support members 14 receive and support the base of the container 10 stacked thereon.

There is thus described a container 10 that includes support members 14 for supporting a further container 10 in a stacked condition of the containers 10. The support members 14 extend only partially across the load receiving space 16 of the container 10 and, thereby, occupy only a small amount of room.

The main part 54 of the lid 24 has a flat upper surface 56, so that, if desired, the lids 24 can be used to allow the upper containers 10 to be stacked on the lids 24 of the containers 10 below.

Various modifications may be made without departing from the scope of the invention. For example, the first and/or second walls 18, 20 may have vented holes 60 (see FIGS. 11 and 12).

An example of a modified container is shown in FIGS. 11 to 15. In these Figures, a container 110 and a lid 124 are shown.

The container 110 and the lid 124 have many of the same features as the container 10 and the lid 24 shown in FIGS. 1 to 10. These features have been designated in FIGS. 11 to 15 with the same reference numerals as the corresponding features in FIGS. 1 to 10.

The container 110 differs from the container 10 in that each of the second walls 20 includes two pivot formations 134 spaced along the upper edge regions 22 of each of the second walls 20. The pivot formations 134 are shown in FIGS. 11 and 12, and, in more detail, in FIG. 13.

The lid 124 of the container 110 includes two cooperating formations 144 on each of its opposite rim regions 42. The cooperating formations 144 are shown in detail in FIGS. 13 to 15 and extend from the rim regions 42.

Each pivot formation 134 comprises a recess 136 defined in the upper edge region 22 of the second wall 20. Each recess 136 has a lower end 140.

Each pivot formation 134 further includes a lug member 146 within the recess 136. The lug member 146 extends upwardly from the lower end 140. A respective occlusion region 120 of each second wall 20 extends across the recess 136. In FIG. 13, the occlusion region 120 is represented by broken lines on the second wall 20.

Each pivot formation 134 further includes a pair of gripping formations 148 extending downwardly along the occlusion region 120. The gripping formations 148 are aligned with the lug member 146 to define two opposite side openings 150, the purpose of which is explained below.

The lug member 146 and the gripping formations 148 of the occlusion region 120 provide a receiving formation 142 with which the cooperating formations 144 can cooperate to secure the cooperating formations 144 to the pivot formation 134.

The receiving formation 142 has an upper opening 151 between the lug member 146 and the occlusion region 120.

The cooperating formations 144 comprise two pairs of resiliently deformable securing members 152 extending downwardly from each of the opposite rim regions 42 of the lid 124.

Each securing member 152 comprises an inwardly projecting securing portion 154 and a connecting portion 156. The connecting portion 156 is resilient and connects the securing portion 154 to the main part 54 of the lid 124.

The securing portions 154 of each pair of securing members 152 project towards each other. The securing members 152 can be received by the respective receiving formations 140 via the side openings 150. This secures the cooperating formations 144 to the pivot formations 134 to mount the lid 124 on the container 110.

When so mounted, the lid 124 can be moved to an open position by releasing the cooperating formations 144 on one of the rim regions 42 from the pivot formations 134 along one of the second walls 20.

Releasing the cooperating formations 144 can be done by deforming the securing members 152 of each cooperating formation 144 away from each other, out of the respective receiving formation 140.

The lid 124 can then be pivoted about the pivot formations 134 on the opposite second wall 20 to the open position shown in FIG. 11.

In some circumstances, the user may open the lid 124 to a position in which the lid 124 is moved beyond the position shown in FIG. 11. When this happens, the securing portions 154 are released from the pivot formations 134 through the upper opening 151.

In effect, the securing portions 154 snap out of the pivot formations 134 through the upper opening 151, thereby preventing damage to the pivot formations 134 or the cooperating formations 144.

An example of a modified container is shown in FIGS. 16 to 19.

In this example, the hinge connections between the support member 14 and the channels have been modified. The hinge members 137 are undersized relative to the channels 39, so as to be free to translate in a vertical direction as a result of rotation of the support member 14 between the support position and the non-support position.

As the support member 14 rotates towards the non-support position, a hinged long edge 130A of the support member 14 presses down on the underlying section of the ledge 35 of the first wall 18. To prevent an interference between 130A and 35, the hinge members 137 are able to translate upwardly within the channels 39 as the support member 14 is rotated towards the non-support position.

A further advantage is that when the support member 14 is in the non-support position, its long edge 130A rests on the ledge 35. This provides a load path that does not pass through the hinge members 137, to improve durability.

Although in FIGS. 16 to 19 the hinge members 137 have been modified in a particular way (semi-circular shaped hinge members) to achieve the described effect, it would be appreciated that the same result could alternatively be achieved if the channel 39 is vertically elongated. The key difference compared to the example of FIG. 4 is that the hinge members 137 are not against the top of the channels 39 when the support member 14 is in the support position, therefore, the hinge members 137 have space to move upwards.

FIG. 17 separately illustrates an alternative shape of the planar portion 30, showing that the planar portion 30 of an individual support member 14 does not necessarily have to be continuous from corner to corner of the support member 14. That is, a free edge 130B of the support member 14 does not necessarily have to be a constant fixed distance from the parallel long edge 130A of the support member 14. FIG. 17 illustrates a discontinuous planar portion 30, from which material has been removed in a central region of the support member 14 between the hinge members 137. Removing this material, away from the corners of the container, reduces material usage without compromising the supporting ability of the support member 14.

1. A container comprising a container and a lid, the container comprising a wall arrangement defining a load receiving space, and a support member attached on the wall arrangement, the support member being movable between a support position and a non-support position, wherein, in the Support position, the support member extends at least partially across the load receiving space, the support member having a planar portion to support a further container in a stacked condition on the container, and wherein an upper edge region of the wall arrangement of the container includes pivot formations to provide a pivotal mounting for the lid.

2. The container arrangement of claim 1, wherein in the support position, the support member extends transverse relative to the wall arrangement, and wherein in the non-support position, the support member extends upwardly relative to the wall arrangement.

3. The container arrangement of claim 1, wherein in the non-support position, the support member projects above the wall arrangement.

4. The container arrangement of claim 1, wherein the container comprises two of the aforesaid support members.

5. The container arrangement of claim 4, wherein the support members are arranged opposite each other.

6. The container arrangement of claim 5, wherein the wall arrangement comprises two opposite first walls and two opposite second walls, and wherein the support members are arranged on the opposite first walls.

7. The container arrangement of claim 6, wherein the support members are pivotally attached to upper edge regions of the opposite first walls.

8. The container arrangement of claim 6, wherein each support member is pivotally attached to the respective first wall by a hinge and a hinge member, wherein the hinge is provided on the first wall, and wherein the hinge member extends from the planar portion.

9. (canceled)

10. The container arrangement of claim 6, wherein the container has a first dimension extending across the top of the load receiving space between the first walls, and a second dimension extending across the top of the load receiving space between the second walls, wherein each planar portion has a width extending between the first walls, and wherein the width of each planar portion is such that, in the support position, the planar portions of both support members extend across an aggregate of 15% to 25% of the first dimension of the container.

11. (canceled)

12. The container arrangement of claim 6, wherein the second walls have receiving formations to receive the support members in the support position.

13. The container arrangement of claim 12, wherein each receiving formation comprises an indentation defined by the second wall, and wherein each indentation is an inwardly facing indentation.

14. The container arrangement of claim 13, wherein each indentation provides a ledge on which the corresponding support member is seated in the support position, wherein each indentation is defined in an upper edge region of the second wall adjacent the first walls.

15. The container arrangement of claim 6, wherein each support member has a locating formation on the planar portion, wherein the locating formation cooperates with a corresponding formation on the further container or on the lid to locate the further container, or the lid, on the support member.

16. The container arrangement of claim 15, wherein the corresponding formation on the further container is the perimeter of a base of the further container.

17. (canceled)

18. (canceled)

19. The container arrangement of claim 1, wherein the pivot formations are provided on the opposite second walls of the wall arrangement, therefore the pivot formations allow the lid to pivot between open and closed positions about either of said opposite second walls.

20. The container arrangement of claim 19, wherein each pivot formation comprises a recess defined in an upper edge region of one of the second walls, wherein each pivot formation further includes a pair of upstanding members extending across the recess.

21. The container arrangement of claim 20, wherein the lid includes cooperating formations for cooperating with the upstanding members, wherein the cooperating formations cooperate with the upstanding members to allow the lid to pivot about said upstanding members between the open and closed positions.

22. (canceled)

23. The container arrangement of claim 21, wherein the lid has opposite rim regions, and wherein at least one of the cooperating formations is provided on each of said opposite rim regions.

24. (canceled)

25. The container arrangement of claim 19, wherein the lid is movable from the closed position to a first open position, in which the lid is pivoted about the pivot formation on one of said opposite second walls, and wherein the lid is movable from the closed position to a second open position, in which the lid is pivoted about the pivot formation on the other of said opposite second walls.

26. A system comprising a conveying apparatus and a container,
the container comprising a wall arrangement defining a load receiving space, and a support member attached on the wall arrangement, the support member being movable between a support position and a non-support position, wherein, in the support position, the support member extends at least partially across the load receiving space, the support member having a planar portion to support a further container in a stacked condition on the container,
the conveying apparatus comprising a conveyor and an urging member to urge the support member from the non-support position to the support position.
